(19) United States
(12) Patent Application Publication
(10) Pub. No.: US 2013/0099894 A1
(43) Pub. Date: Apr. 25, 2013

(54) BS meter

(71) Applicant: Kevin Haltigan, Stokes, NC (US)

(72) Inventor: Kevin Haltigan, Stokes, NC (US)

(21) Appl. No.: 13/317,455

(22) Filed: Oct. 19, 2011

(51) Int. Cl. G08B 7/06; G04B 47/00

(52) U.S. Cl. 340/6.1; 368/10

(57) ABSTRACT

A BS meter with a hollow housing containing a microprocessor, a receiving circuit, a pair of marker members that can be illuminated by a plurality of LEDs, a PC board, a power supply, a sound amplifying circuit and a speaker. A representation of a bull sits on top of the housing. The housing includes an aperture covered by tinted front window. The first and second marker members are located behind the front window The transmitter has first and second activation buttons and is capable of activating the electronic components via the receiving circuit. The illuminated markers can be seen through the tinted window when a user presses the first or second activation button, and the speaker emits a sound of a bull bellowing. A preferred embodiment includes a digital clock assembly is placed within the hollow housing.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of novelty sound and light emitting devices and more specifically to a BS meter that simulates a device that detects false statements.
There are times in life when people stretch the truth or tell out and out lies. When another person hears such a comment, he or she may claim that it is BS which is an abbreviation for the common term “Bull shit”
A number of games have been developed in the past that center on the truthfulness of an answer. For example James J. Barr, in his patent U.S. Pat. No. 4,300,763 discloses a psychological game that includes an electronic device that displays LEDs that indicate “credible”, “almost truth” and “forget it”.
However, none of the prior art patents show a novel device that can be operated remotely by a witness to an untruth told by another person and that shows the offending person an illuminated marker indicating level of untruth or “BS” and also, for a more complete effect, emits the sound of a bull bellowing.

### BRIEF SUMMARY OF THE INVENTION

The primary object of the invention is to provide a device that simulates the detection of a false or exaggerated statement made by a person.

Another object of the invention is to provide a device that can be triggered from a distance to cause a marker within the simulated detection device to become illuminated.

Another object of the invention is to provide a device that includes an audio sound of a bull bellowing when the device is triggered.

A further object of the invention is to provide a device that includes a rendition of a bull whose eyes become illuminated when the device is triggered.

Yet another object of the invention is to provide a device that allows the user to trigger one of several markers depending on the degree of the false or exaggerated statement made by a person.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a BS meter comprising: A main hollow housing, a microprocessor, a receiving circuit, a first marker member, a second marker member, a plurality of LEDs, a PC board, a power supply, a sound amplifying circuit, a speaker, a representation of a bull, a transmitter circuit, a pocket sized transmitter housing, said main hollow housing including an aperture covered by tinted front window portion, said first and second marker members located behind said front window portion, said first and second marker members capable of being illuminated by said LEDs, said receiving circuit, said microprocessor, said speaker, said power supply and said sound amplifying circuit all mounted to said PC board, said PC board mounted within said hollow housing, said LEDs mounted in close proximity to said first and second marker members, said power supply powering all said electronic components within said housing, said housing hollow including a plurality of apertures allowing sound from said speaker to exit said housing, said transmitter having first and second activation buttons, said transmitter capable of activating said electronic components via said receiving circuit, said first marker member caused to illuminate by said LEDs and be seen through said tinted window when a user presses said first activation button, said second marker member caused to illuminate by said LEDs when said user presses said second activation button, and said speaker emitting a sound of a bull bellowing when said first or said second transmitter button is pressed by said user.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of the invention with the first marker member showing.

FIG. 3 is a perspective view of the invention with the second marker member showing.

FIG. 4 is a rear view of the invention with the back cover removed.

FIG. 5 is a side section view of the invention.

FIG. 6 is a rear view of the invention.

### DETAILED DESCRIPTION OF THE PREFERRED EMBODIMENTS

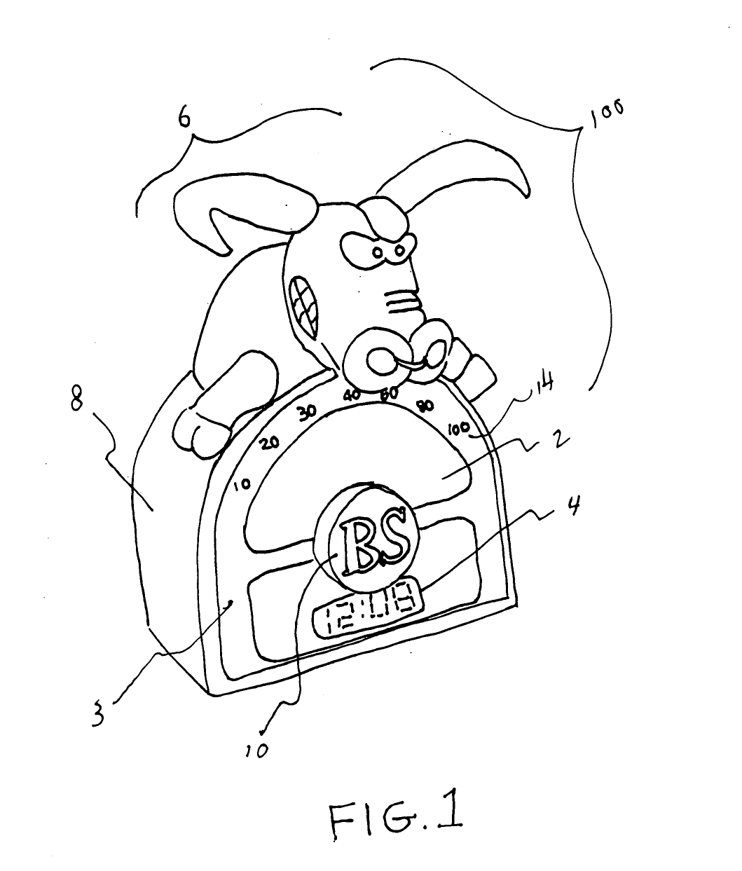

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.
Referring now to FIG. 1 we see a perspective view of the novel BS meter of the present invention 100. A hollow housing 8 includes a front panel 3 that has a tinted window 2 surrounded by indices 14 which constitute a BS meter scale. The letters “BS” 10 are mounted on a disk shaped protrusion. An optional digital clock 4 is located at the bottom of the front panel 3. A sculpturally representation of a bull 6 is fixed to the top surface of the housing 8.

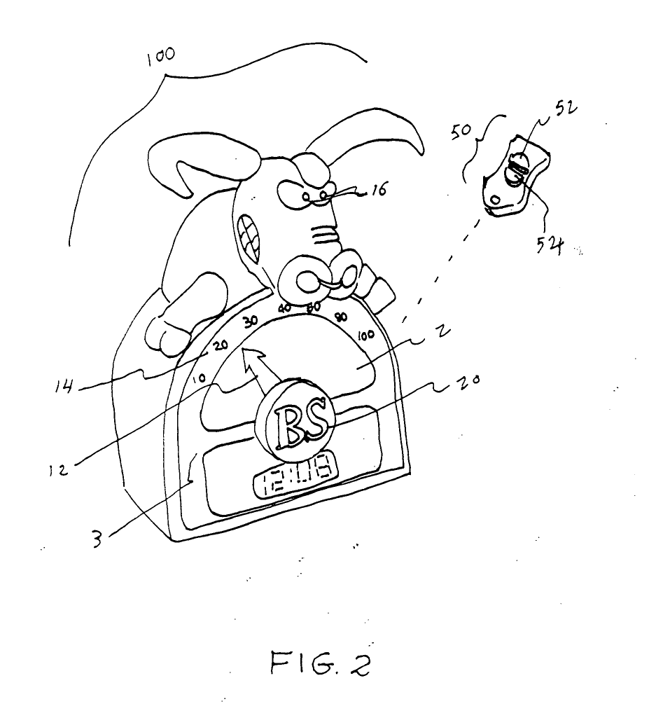

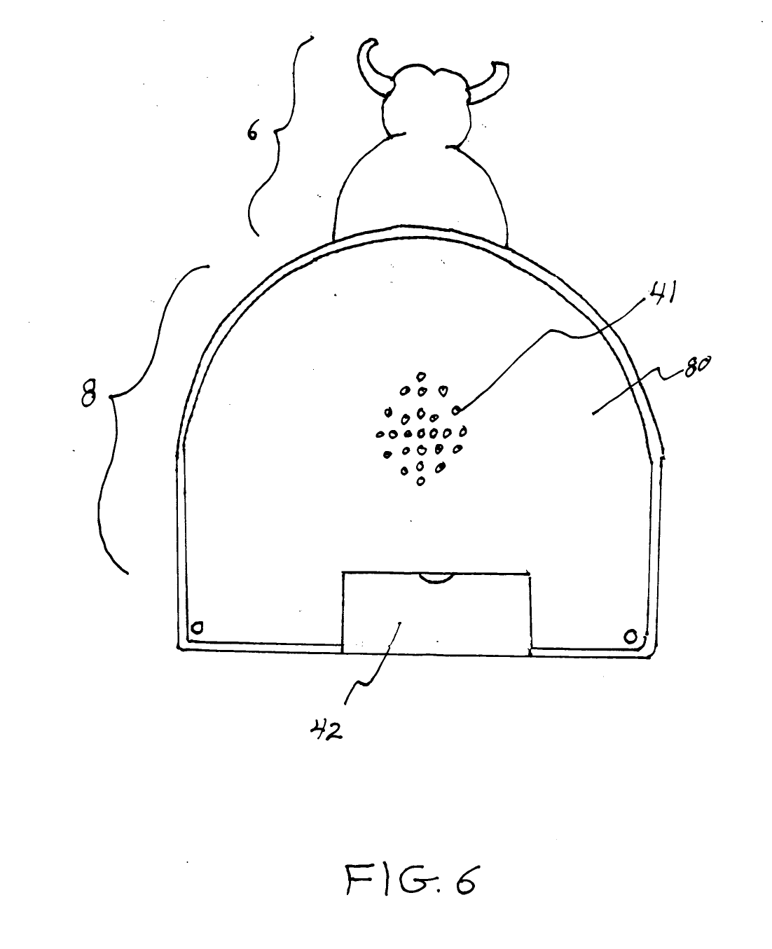

FIG. 2 shows a perspective view of the invention 100 where a button 52 on a portable transmitter device 50 has been pressed, causing a first arrow shaped marker member 12 to be illuminated so that it shows through the tinted window 2 of the front panel 3. In addition to the illumination of first marker 12, the eyes 16 of the bull 6 also light up as well as the BS lettering 20. Additionally, an audible sound of a bull bellowing is played and emitted through apertures 41 at the rear panel 80 of the housing as shown in FIG. 6. The transmitter device 50 can be stored in a user's pocket so that when the user hears a person in the vicinity of the invention 100 make a statement that is somewhat exaggerated or untrue, the user can press button 52 to activate the lights and sounds of the invention 100, as a humorous way to notify the offending party that the statement he or she just made is questionable.

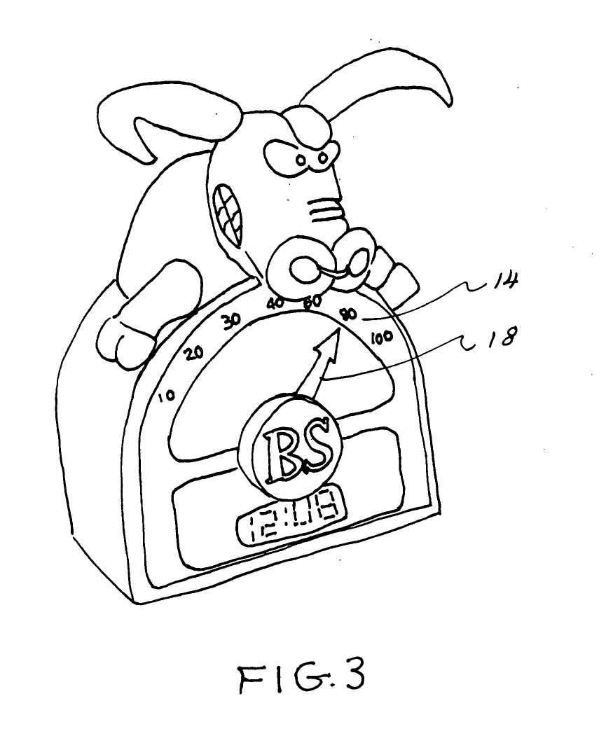

FIG. 3 shows a perspective view of the invention after the user has pressed button 54 of the transmitter. This indicates that the degree of untruth made by a person is even greater than the untruth measured as shown in FIG. 2. Therefore the second marker 18 is illuminated and measures higher on the BS meter scale 14.

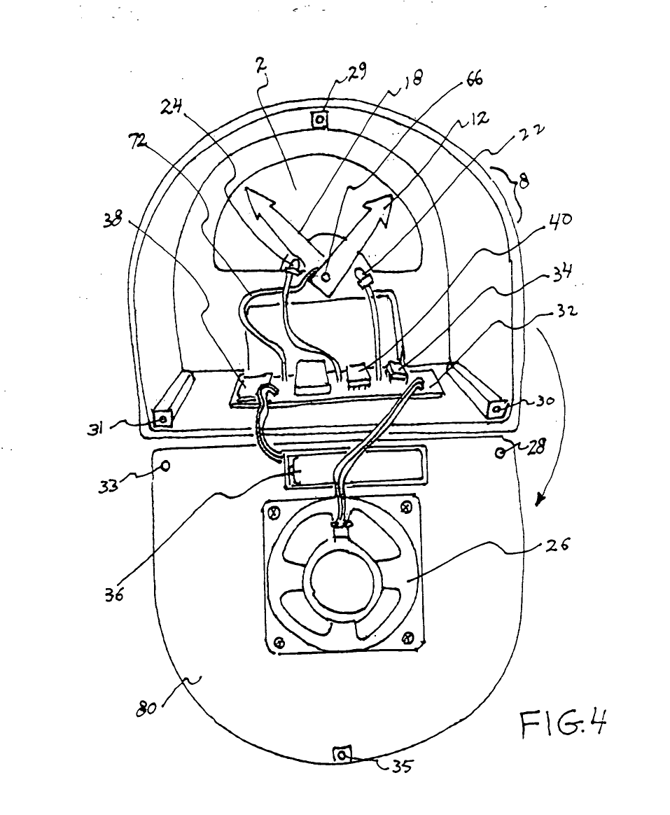

FIG. 4 shows a rear view of the invention with the rear panel 80 of housing 8 removed. Rear panel 80 is normally held in place to housing main body 8 by means of a standard screw as it passes through apertures 28, 33, 35 and threaded apertures 30 29, 31. Batteries 36 at as a power supply and attached by electrical wire to PC board 32. Speaker 26 is mounted to the rear panel 80 and connected by electrical wires to PC board 32. First marker member 12 and second marker member 18 can be seen and are pinned to the front panel by post member 66. LED illuminating member 22 is located in close proximity to first member marker member 12 and can cause tinted fluorescent first marker member 12 to be illuminated so that it shines through the tinted front window 2 as shown in FIG. 2. Similarly, LED illuminating member 24 can illuminated second marker member 18. One or the other of the marker members 12, 18 become illuminated when either button 52, 54 of transmitter 50 is pressed and receiving circuit 38 signals microprocessor 40 to activate the LEDs 22, 24. Additionally, an additional LED, not shown, is located in front of first and second marker members and connected by electrical wires 72 and illuminating the transparent tinted lettering “BS” 10 located on the front panel 3. Also, the microprocessor 40 signals voice chip 34 to send a pre-recorded bellowing sound to speaker 26. Finally, microprocessor 40 also causes LEDs located behind the bull's 6 eyes 16 to illuminate.

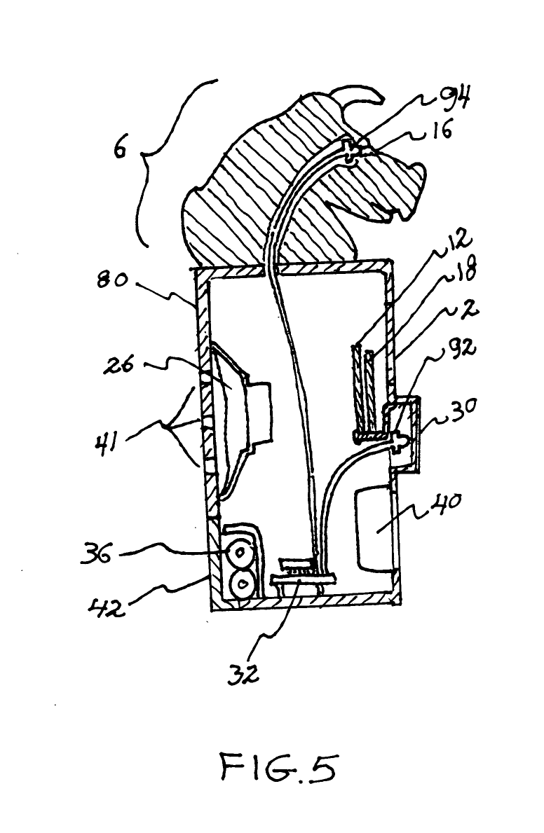

FIG. 5 shows a side section view of the invention that bisects the housing 8 and bull sculpture 6. Speaker 26 can be seen mounted to rear housing plate 80. Apertures 41 can be seen in rear panel 80 allowing sound from speaker 26 to travel outwards. The LED 92 that illuminates the letters “BS” 30 can be seen as well as the LED used to illuminated the eye 16 of the bull 6. Battery power supply 36 can be seen as well as removable battery door 42. Standard digital clock assembly 4 can be seen at the lower forward positron within the housing 8. PC board 32 and some of its electrical components can be seen at the lower middle portion of the housing 8.

FIG. 6 shows a rear view of the invention 100 clearly showing rear panel 80 which includes apertures 41 and battery door 42.

The above description and Figures show a novel simulation of a meter that displays a measurement of the degree of untruth told by a person.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. BS meter comprising:
A hollow housing;
a microprocessor;
a receiving circuit;
a first marker member;
a second marker member;
a plurality of LEDs;
a PC board;
a power supply;
a sound amplifying circuit;
a speaker;
a representation of a bull;
a transmitter circuit;
a pocket sized transmitter housing;
said housing including an aperture covered by tinted front window portion;
said first and second marker members located behind said front window portion;
said first and second marker members capable of being illuminated by said LEDs;
said receiving circuit, said microprocessor, said speaker, said power supply and said sound amplifying circuit all mounted on said PC board;
said PC board mounted within said hollow housing;
said LEDs mounted in close proximity to said first and second marker members;
said power supply powering all said electronic components within said housing;
said housing including a plurality of apertures allowing sound from said speaker to exit said housing;
said transmitter having first and second activation buttons;
said transmitter capable of activating said electronic components via said receiving circuit;
said first marker member caused to illuminate by said LEDs and be seen through said tinted window when a user presses said first activation button;
said second marker member caused to illuminate by said LEDs when said user presses said second activation button; and
said speaker emitting a sound of a bull bellowing when said first or said second transmitter button is pressed by said user.

2. BS meter as claimed in claim 1 further comprising a digital clock assembly is placed within said hollow housing and said hollow housing includes an aperture to allow the digits of said clock to be seen by a viewer.

3. BS meter as claimed in claim 1 further comprising a radial array of numbers printed on the outside of said housing and surrounding said tinted front window portion allowing said user to see the corresponding numerical value of said first or second markers.

4. BS meter as claimed in claim 1 further comprising a additional pair of LEDs mounted in said bull's eyes;
said eye LEDs becoming illuminated as said bellowing sound is occurring.
